(19) United States
(12) Patent Application Publication
(10) Pub. No.: US 2025/0247021 A1
(43) Pub. Date: Jul. 31, 2025

(54) VIBRATION ACTUATOR, OPTICAL DEVICE, AND ELECTRONIC DEVICE

(71) Applicant: CANON KABUSHIKI KAISHA, Tokyo (JP)

(72) Inventors: KEI SUEFUJI, Tokyo (JP); TAIGA NAGATA, Kanagawa (JP)

(21) Appl. No.: 19/033,924

(22) Filed: Jan. 22, 2025

(30) Foreign Application Priority Data
Jan. 25, 2024 (JP) 2024-009254

(51) Int. Cl. H02N 2/06; G02B 21/26; H02N 2/02

(52) U.S. Cl. CPC H02N 2/06; H02N 2/026; H02N 2/028; G02B 21/26

(57) ABSTRACT

A vibration actuator includes a vibrating body including an electro-mechanical energy conversion element, a contact body configured to be in contact with the vibrating body and relatively movable with respect to the vibrating body, a control unit configured to input an electric signal to the vibrating body, a platform configured to support the vibrating body, the contact body, and the control unit, and a communication unit configured to receive electric power and an electric signal from an external device.

### FIELD

The present disclosure relates to a vibration actuator, an optical device, and an electronic device.

### DESCRIPTION OF THE RELATED ART

A vibration actuator normally produces a driving force by vibration excited in the vibrating body in pressure contact with the driven body (a contact body) frictionally driving the vibrating body and the driven body relative to each other. This configuration enables highly accurate and quiet driving with a simple and thin structure. Vibration actuators have been applied as driving motors for lens barrels each including a movable lens, rotary drive devices, such as ones for camera tripod heads, production equipment, such as that for factory automation (FA), and office automation (OA) devices.

For example, Japanese Patent Application Laid-Open No. 2006-175531 discusses a technique of a compact manipulator, the technique of which applies a sinusoidal drive voltage to a vibration actuator with a piezoelectric element to allow linear and rotational operations.

Specifically, in a manipulator discussed in Japanese Patent Application Laid-Open No. 2006-175531, a power supply device is connected to a drive device (a drive circuit) that generates control signals for a piezoelectric element, and the power supply device supplies power for driving the piezoelectric element. In addition, control signals from a personal computer connected to a control drive device are sent to the drive device.

In some cases, a vibration actuator is provided with the main body of an encoder (a detector) and a scale (a portion to be detected) for detecting the position of the vibration actuator to position the vibration actuator with high accuracy.

However, in the vibration actuator discussed in the above conventional example, the control drive device is disposed at a position separated from the vibration actuator or the main body of the encoder, the position detection of the vibration actuator is not sufficiently accurate in some cases.

Specifically, drive signals of the vibration actuator are normally high-voltage sinusoidal signals of approximately 100 volts (V) peak-to-peak (Vpp) to 400 Vpp. On the other hand, position signals from the main body of the encoder are normally low-voltage signals of approximately 3 V to 5 V. Thus, with the wiring of drive signals and the wiring of position signals of the encoder disposed close to each other, position signals of the encoder can be affected by drive signals, increasing noise in the position signals.

In other words, with the control drive device disposed away from the vibration actuator as in the conventional example, the wiring of drive signals that is connected to the control drive device and the wiring of the encoder are extended. That results in more areas where the wiring of drive signals and the wiring of the encoder are close to each other. This may increase noise in position signals, making the driving of the vibration actuator controlled by the position signals unstable, deteriorating the positioning accuracy.

### SUMMARY

The present disclosure is directed to providing a vibration actuator allowing highly accurate driving. The present disclosure is also directed to providing an optical device or an electronic device capable of highly accurate driving.

According to some embodiments, a vibration actuator includes a vibrating body including an electro-mechanical energy conversion element, a contact body configured to be in contact with the vibrating body and relatively movable with respect to the vibrating body, a control unit configured to input an electric signal to the vibrating body, a platform configured to support the vibrating body, the contact body, and the control unit, and a communication unit configured to receive electric power and an electric signal from an external device.

Further features of the present disclosure will become apparent from the following description of exemplary embodiments with reference to the attached drawings.

### BRIEF DESCRIPTION OF THE DRAWINGS

FIGS. 1A and 1B are perspective views each schematically illustrating the configuration of a vibration actuator according to a first exemplary embodiment.

FIGS. 2A and 2B are exploded perspective views of the vibration actuator according to the first exemplary embodiment.

FIG. 3 is a partially exploded perspective view of a drive unit included in the vibration actuator according to the first exemplary embodiment.

FIGS. 4A and 4B are perspective views illustrating a first vibration mode and a second vibration mode according to the first exemplary embodiment.

FIG. 5 schematically illustrates a wiring pattern on a relay unit of the vibration actuator according to the first exemplary embodiment.

FIGS. 6A and 6B are perspective views each schematically illustrating the configuration of a vibration actuator according to a second exemplary embodiment.

FIG. 7 is a partially exploded perspective view of a drive unit of the vibration actuator according to the second exemplary embodiment.

FIG. 8 is a perspective view schematically illustrating the configuration of a microscope according to a third exemplary embodiment.

### DESCRIPTION OF THE EMBODIMENTS

The inventors have discussed a configuration capable of driving a vibration actuator with high accuracy. As a result, it has been found that, with the main body of an encoder and a scale for position detection disposed away from each other, for example, in different housings or members, some position detections were insufficient. As a result of further studying the configuration, it has been found that a vibration actuator was driven with high accuracy with a platform provided that supports the vibrating body, the contact body, the control unit, and the detector.

Hereinafter, various exemplary embodiments, features, and aspects of the present disclosure will be further described with reference to the drawings.

### Basic Configuration of Vibration Actuator

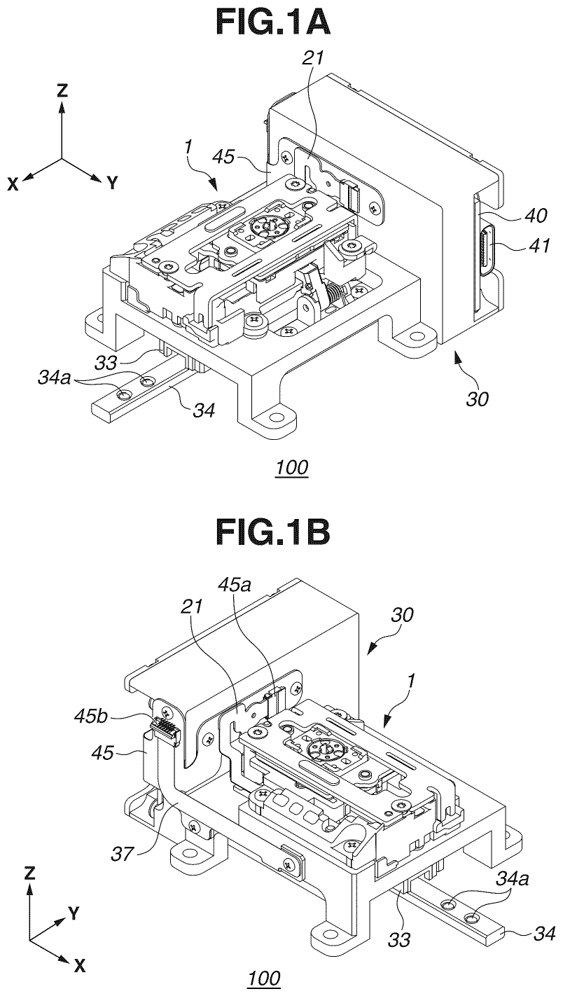

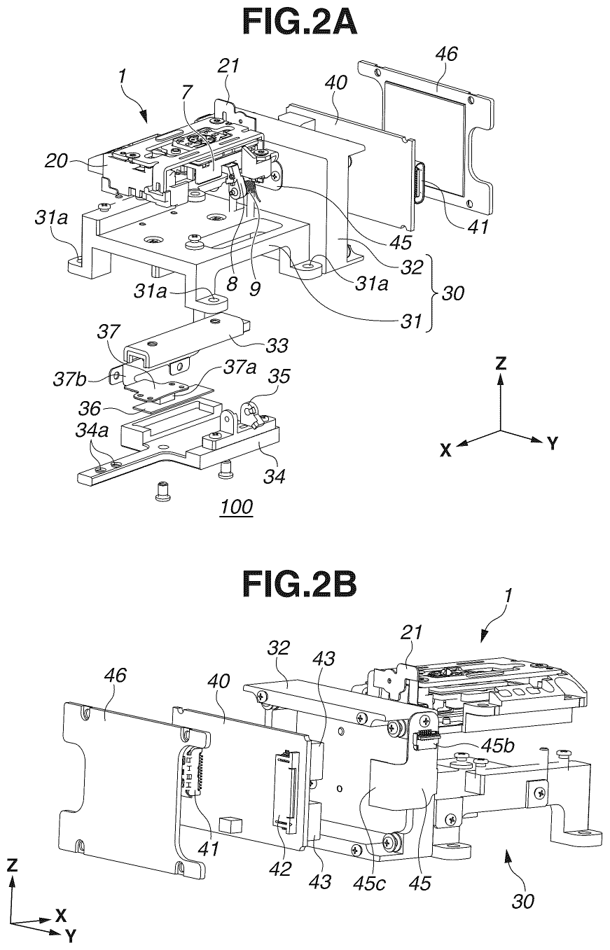

A first exemplary embodiment will be described. FIGS. 1A and 1B are perspective views each schematically illustrating the configuration of a vibration actuator 100 according to a first exemplary embodiment. FIG. 1A is a perspective view where a communication unit 41 is seen, and FIG. 1B is a perspective view where an encoder 37 is seen. FIGS. 2A and 2B are exploded perspective views of the vibration actuator 100.

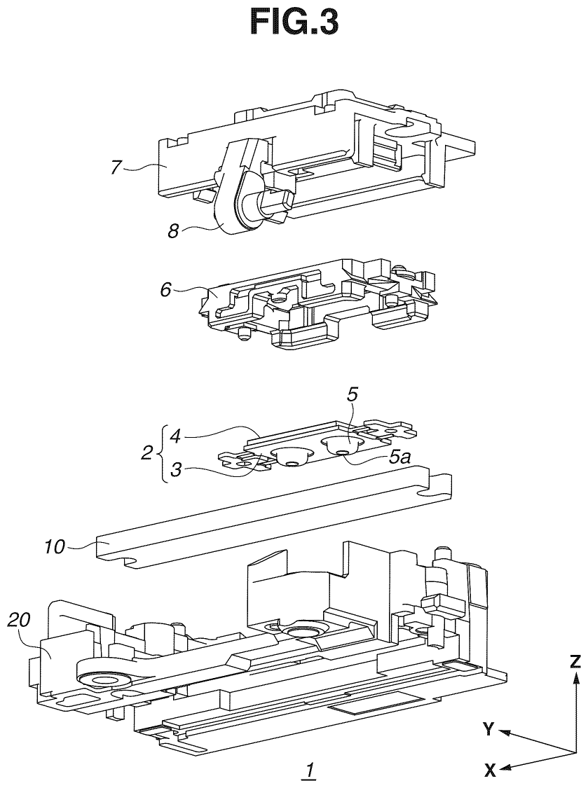

FIG. 2A is an exploded perspective view where the communication unit 41 is seen, and FIG. 2B is a partially exploded perspective view where a drive circuit 40 is seen near the front. FIG. 3 is a partially exploded perspective view of a drive unit 1. The vibration actuator 100 includes a vibrating body 2, a holding member 6, a support member 7, a contact body 10, a platform 30, a linear guide 33, the encoder 37, and the drive circuit 40.

The vibrating body 2 includes an elastic body 3, two protruding parts 5 provided on one surface of the elastic body 3, and a piezoelectric element 4 provided on a surface of the elastic body 3, the surface being opposite to the surface on which the protruding parts 5 are provided. The contact body 10 can be driven with at least one protruding portion 5.

The elastic body 3 formed in an approximately rectangular and flat plate shape may include, for example, a metal material, such as martensitic stainless steel. A quenching treatment may be applied to the elastic body 3 as a hardening treatment for enhancing durability. The protruding parts 5 are formed to have a thickness that provides spring property, and can be formed integrally with the elastic body 3 by, for example, performing pressing working on a plate material that forms the elastic body 3. However, the formation method for the protruding parts 5 is not limited to any particular method, and the protruding parts 5 may be fixed to the elastic body 3 by welding. A hardening treatment, such as a quenching treatment, is favorably applied to tips 5a (upper surfaces) of the protruding parts 5 to increase their resistance to abrasion because the tips 5a frictionally slide on the contact body 10.

The contact body 10 may contain a metallic material, such as stainless steel. A hardening treatment, such as a nitriding treatment, is favorably applied to the frictional sliding surface of the contact body 10 with the protruding parts 5 to increase its resistance to abrasion.

The piezoelectric element 4, which is an example of an electro-mechanical energy conversion element that converts electrical energy into mechanical energy, may be bonded to the elastic body 3 by an adhesive. The piezoelectric element 4 has a structure in which electrodes having a predetermined shape are formed on both surfaces of a piezoelectric ceramic plate.

When the vibration actuator 100 is driven, a drive voltage (an alternating-current voltage) of a predetermined frequency is applied from a power supply flexible portion 21 to the electrodes of the piezoelectric element 4. The applied voltage excites vibrations of a first vibration mode and a second vibration mode, which will be described below, in the vibrating body 2, and causes the protruding parts 5 to generate elliptical motions in a plane including a direction connecting the two protruding parts 5 and the protruding direction of the protruding parts 5. Thus, the protruding parts 5 frictionally drive (hereinafter, simply referred to as “drive”) the contact body 10, and the contact body 10 and the vibrating body 2 are linearly driven relative to each other, that is, can be moved relative to each other.

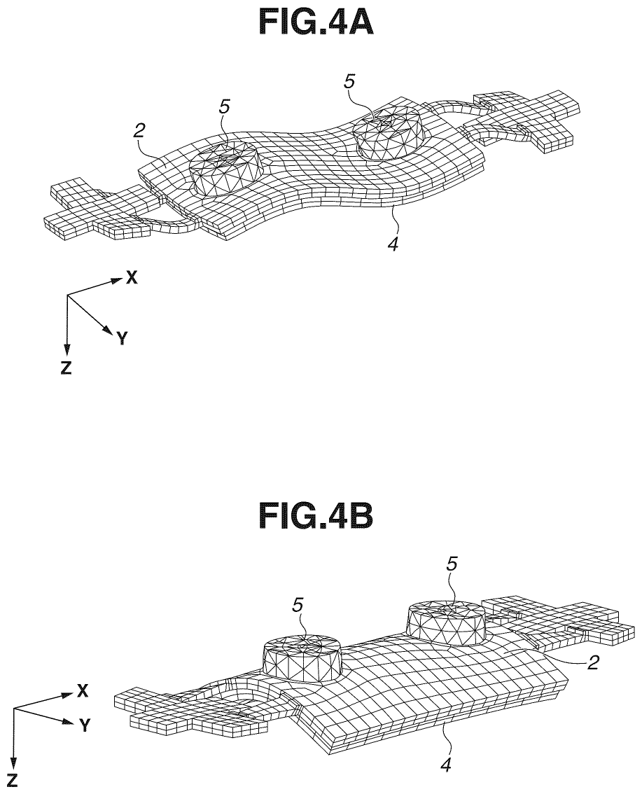

FIGS. 4A and 4B are perspective views illustrating natural vibration modes in which the vibrating body is excited to drive the vibration actuator 100 (to move the vibrating body 2 and the contact body 10 relative to each other). FIG. 4A is a perspective view illustrating a first vibration mode in which the vibrating body 2 is excited to drive the vibration actuator 100. FIG. 4B is a perspective view illustrating a second vibration mode in which the vibrating body 2 is excited to drive the vibration actuator 100.

In FIGS. 4A and 4B, to facilitate understanding of the deformed shapes, the amount of displacement of the vibrating body 2 is enlarged compared with the shape thereof. An X direction, a Y direction, and a Z direction illustrated in each drawing are defined to describe the first vibration mode and the second vibration mode. The X direction is a direction connecting (the tips of) the two protruding parts 5 and is also a longer side direction of the vibrating body. The Z direction is a protruding direction of the protruding parts 5 and is also a direction in which the vibrating body and the contact body are brought into pressure contact. The Y direction is a direction perpendicular to the X direction and the Z direction, and is also a shorter side direction of the vibrating body.

The first vibration mode is a mode in which a second-order bending vibration (a vibration having two antinodes) is generated in the X direction (the longer side direction of the vibrating body), and has three vibration nodes (hereinafter, simply referred to as “nodes”) parallel to the Y direction. The protruding parts 5 (the tips thereof) perform reciprocating motions in the X direction by the vibration of the first vibration mode. In this case, the protruding parts 5 disposed at positions corresponding to the nodes or in the vicinity of the nodes in the vibration of the first vibration mode (such that the protruding parts 5 superpose the positions corresponding to the nodes in the vibration of the first vibration mode) maximize the displacement of (the tips of) the protruding parts 5 in the X direction.

The second vibration mode is a mode in which a first-order bending vibration (a vibration having one antinode) is generated in the Y direction (the shorter side direction of the vibrating body), and has two nodes parallel to the X direction. The protruding parts 5 perform reciprocating motions in the Z direction by the vibration of the second vibration mode. In this case, the protruding parts 5 disposed at a position corresponding to the antinode or in the vicinity of the antinode in the second vibration mode (such that the protruding parts 5 superpose the position corresponding to the antinode in the vibration of the second vibration mode) maximize the displacement of the protruding parts 5 in the Z direction.

Thus, the combination of the first vibration mode and the second vibration mode enables an elliptical motion in the approximately Z-X plane to be generated at the tips of the protruding parts 5, generating a driving force for driving the vibrating body 2 approximately in the X direction. In this case, each of the two protruding parts 5 disposed at the position corresponding to the nodes of the first vibration mode and the position corresponding to the antinode of the second vibration mode or in the vicinity thereof maximize the vibration displacement of (the tips of) the protruding parts 5, producing high output.

As illustrated in FIGS. 1A, 1B, 2A, 2B, and 3, the vibrating body 2 is fixed to the holding member 6 near the ends (at fixing portions extending from the flat-plate portion in the longer side direction) (a direction connecting the tips 5a of the two protruding parts 5)) of the vibrating body 2 in the longer side direction by a method, such as bonding or welding.

The holding member 6 has a structure in which the holding member 6 is freely slidable in the Z direction with respect to the support member 7 so that the vibrating body 2 can apply pressure to the contact body 10. The holding member 6 is fixed to the support member 7 in the X direction.

The support member 7 is provided with a drive connection part 8 and a drive connection spring 9, which are connected to a connection holding part 35, which will be described below, to transmit the driving force of the vibrating body 2.

The drive connection spring 9 is a torsion spring, and generates biasing forces in the X direction and the Z direction. The biasing force in the X direction acts to reduce the backlash in the driving direction, and the biasing force in the Z direction acts to reduce the backlash of the linear guide 33.

The respective ends of the contact body 10 in the longer side direction are fixed to a base 20 with screws.

The platform 30 includes a drive mounting part 31 and a circuit mounting part 32, and the drive mounting part 31 and the circuit mounting part 32 are fixed with screws. However, the drive mounting part 31 and the circuit mounting part 32 may be fixed by an adhesion or integrally formed.

The base 20 of the drive unit 1 is fixed to the drive mounting part 31 with screws. Thus, the vibrating body 2 is driven in the X direction relative to the contact body 10, the base 20 to which the contact body 10 is fixed, and the platform 30 to which the base 20 is fixed.

The drive mounting part 31 has four attachment hole portions 31a, and can be fixed, for example, to a fixing base (not illustrated) on which a drive target is mounted, with screws. The linear guide 33 (a guiding part) that can guide in the X direction and an encoder 37 for position detection are fixed to the drive mounting part 31 with screws.

An output part 34 is fixed to a guiding portion of the linear guide 33 with screws, and the output part 34 is movable in the X direction relative to the platform 30. The output part 34 has an output attachment portion 34a in which female screws are formed, and a drive target (not illustrated) of the vibration actuator 100 can be fixed to the output attachment portion 34a. The output attachment portion 34a may have any other shape, such as holes or pins, as long as the drive target can be attached thereto.

The output part 34 is provided with a connection holding part 35 and a scale 36. The connection holding part 35 is fixed to the output part 34 with screws, and is connected to the drive connection part 8 as described above. Thus, the connection holding part 35 and the output part 34 are integrally driven with the vibrating body 2 via the drive connection part 8, which is integrally driven with the vibrating body 2.

With the above configuration, in the vibration actuator 100, as the vibrating body 2 is driven, the vibrating body 2, the holding member 6, the support member 7, the drive connection part 8, the connection holding part 35, and the output part 34 are integrally driven in the X-axis direction with respect to the fixed contact body 10 and platform 30.

### Position Detection Mechanism of Vibration Actuator

The scale 36 is fixed to the output part 34 approximately parallel to the contact body 10 in the X-axis direction with, for example, an adhesive or an adhesive tape.

Hereinafter, the encoder 37 and the scale 36 will be described. The encoder 37 includes a sensor unit 37a (a detector) and an encoder flexible portion 37b.

The sensor unit 37a detects the relative position (displacement information) between the vibrating body 2 and the contact body 10. Further, the sensor unit 37a may detect absolute positions (positional information) of the vibrating body 2 and the contact body 10. The “displacement information” is information detected by an incremental encoder. The “positional information” is information detected by an absolute encoder.

In the present exemplary embodiment, a reflective optical sensor including a light emitting element and a light receiving element is used as the sensor unit 37a. Light emitted from the sensor unit 37a is reflected by the scale (a to-be-detected part) 36 serving as a reflector, and the sensor unit 37a receives the reflected light. In this way, the displacement information (or the positional information) is detected.

The sensor unit 37a is surface-mounted on the encoder flexible portion 37b by, for example, soldering, and is fixed to the drive mounting part 31 via the encoder flexible portion 37b with screws.

Thus, as the vibrating body 2 and the contact body 10 move relative to each other, the sensor unit 37a moves relative to the vibrating body 2 and the output part 34 together with the contact body 10. As a result, the sensor unit 37a and the scale 36 move relative to each other, and the relative position between the vibrating body 2 and the contact body 10 or the absolute position of the vibrating body 2 and the contact body 10 can be detected.

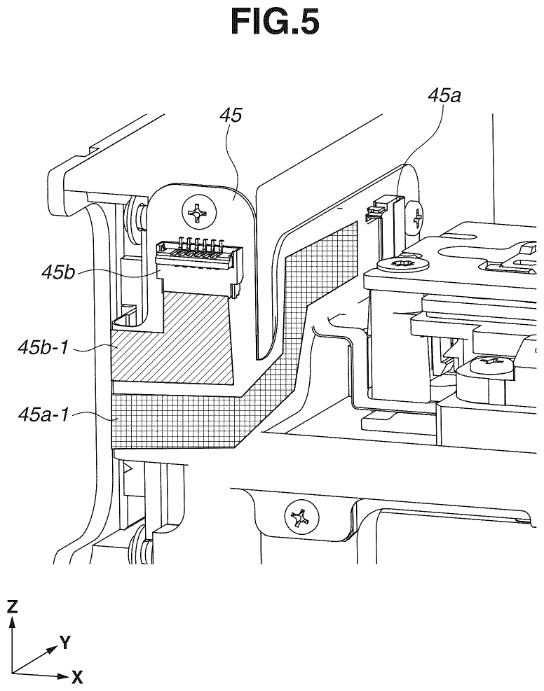

Next, a peripheral structure of the drive circuit 40 that generates a drive voltage to be applied to the vibrating body 2 will be described with reference to FIGS. 1A, 1B, 2A, 2B, and 5. FIG. 5 schematically illustrates a wiring pattern on a relay unit (a relay flexible unit) 45.

The drive circuit 40, the relay unit 45, and a cover part 46 are mounted on the circuit mounting part 32 of the platform 30. The cover part 46 is disposed such that the cover part 46 covers the upper surface of the drive circuit 40, to prevent the entry of dust, etc. into the drive circuit 40 and to prevent short-circuiting due to inadvertent contact with an external device or a user. Openings are formed in the cover part 46 over the upper surfaces of the communication unit 41 and a flexible connector part 42 of the drive circuit 40 to allow their corresponding wires to be connected and disconnected.

The drive circuit 40 (a control unit) includes the communication unit 41, the flexible connector part 42, and a transformer unit 43. A flexible terminal portion 45c of the relay unit 45 is inserted in the flexible connector part 42. The relay unit 45 includes a drive connector part 45a, a drive signal wiring part 45a-1, a sensor connector part 45b, a sensor signal wiring part 45b-1, and the flexible terminal portion 45c.

The power supply flexible portion 21 of the vibrating body 2 is inserted in the drive connector part 45a. Thus, a drive voltage from the drive circuit 40 is supplied to the power supply flexible portion 21 via the drive signal wiring part 45a-1 and the drive connector part 45a of the relay unit 45, driving the vibrating body 2.

The encoder flexible portion 37b of the encoder 37 is inserted in the sensor connector part 45b. Thus, encoder power supply signals from the drive circuit 40 are supplied to the encoder flexible portion 37b via the sensor signal wiring part 45b-1 and the sensor connector part 45b of the relay unit 45, driving the sensor unit 37a. In addition, signals of the displacement information (or the positional information) from the sensor unit 37a are transmitted to the drive circuit 40 via the relay unit 45.

The drive signal wiring part 45a-1 and the sensor signal wiring part 45b-1 are provided in different areas without crossing each other in the relay unit 45. This allows reduction of the influence of noise from high-voltage drive signals on position signals of the encoder.

The expression “provided in different areas” is not limited to the case where the drive signal wiring part 45a-1 and the sensor signal wiring part 45b-1 do not cross each other in a plane of the relay unit. For example, with the relay unit having a multilayer structure, the expression also includes a case where the drive signal wiring part 45a-1 and the sensor signal wiring part 45b-1 are provided such that there is no area where the drive signal wiring part 45a-1 and the sensor signal wiring part 45b-1 cross each other as viewed from the surface on which the drive connector part 45a and the sensor connector part 45b are provided.

In addition, the drive circuit 40, the drive unit 1, and the encoder 37 are disposed on the same platform 30 at short distances from each other. Further, the power supply flexible portion 21 and the encoder flexible portion 37b are fixed to the relay unit 45. In this way, even when the vibration actuator 100 is moved to be mounted on a fixing base (not illustrated), the power supply flexible portion 21 and the encoder flexible portion 37b do not come closer to each other, reducing the influence of drive signals on position signals of the encoder.

The configuration as described above causes position signals of the encoder to be less susceptible to drive signals of the vibration actuator 100, making position signals stable with less noise. As a result, the configuration provides increased accuracy of position detections of the vibration actuator 100, enabling highly accurate driving of the vibration actuator 100.

### Communication Unit

The communication unit 41 is favorably a universal serial bus (USB) connector, connected to a personal computer (an external device) (not illustrated) with a USB cable. In the present exemplary embodiment, a C-connector, which is a so-called Type-C connector, is used.

The personal computer transmits control signals to the communication unit 41 via the USB cable, and supplies a drive voltage for the drive circuit 40 to the communication unit 41 via the USB cable.

A voltage of 5 V is supplied from the personal computer and is boosted by the transformer unit 43 of the drive circuit 40, and a voltage of approximately 100 Vpp to 400 Vpp is applied to the vibrating body 2. In addition, a current of approximately 1 to 3 A is supplied from the personal computer, and an electric power from 5 W to 15 W can be supplied to the vibrating body 2.

This configuration allows sufficient electric power for driving the vibration actuator 100 to be supplied to the communication unit 41. That is, the communication unit 41 is capable of receiving electric power and electric signals as control signals from the personal computer as an external device. Thus, compared with the conventional case where the vibration actuator 100 is driven using a power supply device and a personal computer, the vibration actuator 100 can be driven by a personal computer alone, allowing space-saving of the entire apparatus and cost reduction.

In addition, a dedicated cable for connecting the power supply device and the drive circuit is not needed, and the vibration actuator 100 can be easily driven with a general-purpose USB cable alone. Further, the user of the vibration actuator 100 can drive the vibration actuator 100 via connecting and disconnecting of a USB cable, without performing connecting and disconnecting of the power supply flexible portion 21 and the encoder flexible portion 37b. This can prevent the power supply flexible portion 21 and the encoder flexible portion 37b from being damaged through connections and disconnections of the power supply flexible portion 21 and the encoder flexible portion 37b, providing stable driving of the vibration actuator 100.

In addition, the drive circuit 40 can receive electric power and electric signals by the single communication unit 41, leading to the reduction of one connector compared with two connectors used to input electric power and electric signals separately, providing a compact size of the drive circuit 40.

The drive circuit 40 is disposed so that the USB cable can be connected and disconnected in the Y direction perpendicular to the X direction, which is the driving direction of the vibration actuator 100. This arrangement can prevent the interference with the drive target when the USB cable is connected and disconnected. Further, the drive circuit 40 may be disposed so that the USB cable can be connected and disconnected in the Z direction perpendicular to the X direction.

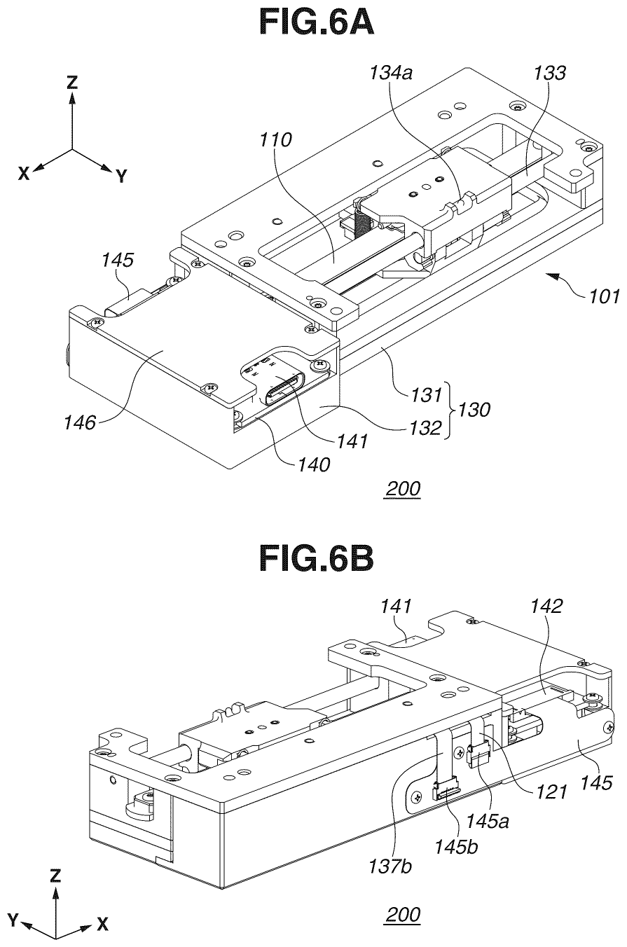

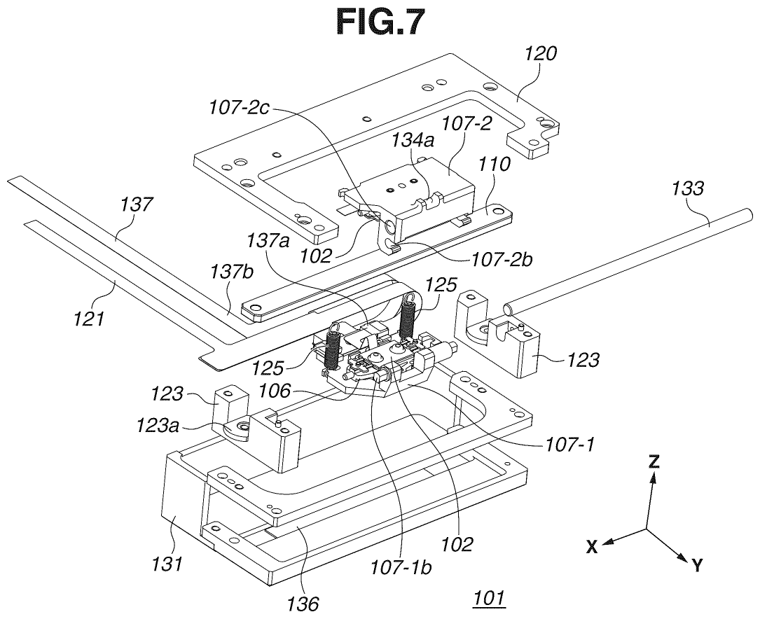

As a second exemplary embodiment, a configuration example of a vibration actuator in a different form from that in the first exemplary embodiment will be described with reference to FIGS. 6A, 6B, and 7. The structure of the present exemplary embodiment differs from that of the first exemplary embodiment illustrated in FIG. 1 in that a drive unit 101 has a configuration in which a contact body 110 is sandwiched between two vibrating bodies 102, as illustrated in FIGS. 6A, 6B, and 7. The other elements of the present exemplary embodiment are the same as those of the first exemplary embodiment described above. Thus, the last two digits of the reference numerals will be denoted by the same numerals as their corresponding ones of the first exemplary embodiment, and redundant description thereof will be omitted.

FIG. 6A is a perspective view schematically illustrating the configuration of a vibration actuator 200 according to the present exemplary embodiment, seen from the side where a communication unit 141 is seen. FIG. 6B is a perspective view schematically illustrating the configuration of the vibration actuator 200 according to the present exemplary embodiment, seen from the side where a relay unit 145 is seen. FIG. 7 is a partially exploded perspective view of a drive unit 101.

The vibration actuator 200 has a configuration in which the contact body 110 is sandwiched between one vibrating body 102 held by a lower support member 107-1 (a support member) and the other vibrating body 102 held by an upper support member 107-2 (a support member). Each of the ends of the contact body 110 in the longer side direction is fixed to a contact body holding part 123 via a damping rubber 123a. The individual damping rubbers 123a are made of, for example, butyl rubber or silicone rubber having high vibration damping performance, and reduce the occurrence of unnecessary vibration in the contact body 110 during the driving of the vibration actuator 200, reducing the occurrence of unusual noise, preventing a decrease in output. The axial ends of a guide bar 133 are fixed to respective contact body holding parts 123.

A drive unit mounting part 131 of a platform 130 is fixed with, for example, an adhesive or an adhesive tape such that a scale 136 is approximately parallel to the contact body 110 and the X-axis direction. The drive unit 101 is formed by connecting the contact body holding parts 123, a base 120, and the drive unit mounting part 131 with, for example, screws.

A through hole portion 107-2c provided in the upper support member 107-2 is slidably fitted to the guide bar 133. Thus, the upper support member 107-2 can be moved relative to the contact body 110 as being guided in the axial direction (X-axis direction) of the guide bar 133 serving as a guide member.

The lower support member 107-1 is positioned with respect to the upper support member 107-2 by engaging a connection pin 107-1b provided on the lower support member 107-1 in a connection receiving portion 107-2b provided on the upper support member 107-2. Thus, the lower support member 107-1 and the upper support member 107-2 are guided along the guide bar 133 and are integrally movable. The contact body 110 and the guide bar 133 are provided approximately parallel to the X-axis direction. A spherical output attachment part 134a is provided on the upper portion of the upper support member 107-2, and is connected to a drive target of the vibration actuator 200 to transmit a driving force.

Tension coil springs 125 are suspended by spring receiving parts provided on the lower support member 107-1 and spring receiving parts provided on the upper support member 107-2, and pull the lower support member 107-1 and the upper support member 107-2. Thus, tips 105a of protruding portions 105 of the vibrating body 102 held by the lower support member 107-1 and the upper support member 107-2, respectively, are maintained in pressure contact with the contact body 110. The components of connecting the lower support member 107-1 and the upper support member 107-2 such that the lower support member 107-1 and the upper support member 107-2 are pulled to each other are not limited to the tension coil springs 125, and may be rubber or conical coil springs.

A power supply flexible portion of the vibrating body 102 held by the lower support member 107-1 and the upper support member 107-2 is inserted into and fixed to a connection connector of a connection flexible portion 121. The connection flexible portion 121 supplies alternating current signals such that the vibrating body 102 held by the lower support member 107-1 and the vibrating body 102 held by the upper support member 107-2 perform elliptical motions in opposite directions relative to each other in an approximately Z-X plane. Thus, the two vibrating bodies 102, each of which is disposed facing the contact body 110, can drive the contact body 110 in the same direction(s). Further, a U-turn portion is formed in the connection flexible portion 121, allowing the connection flexible portion 121 to move integrally with the movement of the vibrating bodies 102 in the X direction. This prevents the connection flexible portion 121 from interfering with the other components, providing stable driving in the X direction.

With the above configuration, the driving of the vibrating bodies 102 causes the vibrating bodies 102, holding members 106, the lower support member 107-1, the upper support member 107-2, and the tension coil springs 125 to be integrally driven in the axial direction of the guide bar 133.

An encoder 137 is mounted on the lower support member 107-1 such that a sensor unit 137a is disposed at a position facing the scale 136 in the Z direction. A U-turn portion is formed in an encoder flexible portion 137b of the encoder 137, preventing the encoder flexible portion 137b from interfering with the other components, providing stable driving in the X direction. In the present exemplary embodiment, a reflective optical sensor including a light emitting element and a light receiving element is also used as the sensor unit 137a.

Next, a peripheral structure of the drive circuit 140 that generates drive voltages to be applied to the vibrating bodies 102 will be described with reference to FIGS. 6A and 6B.

The drive circuit 140, the relay unit 145, and a cover part 146 are mounted on a circuit mounting part 132 of the platform 130.

As in the first exemplary embodiment, the drive circuit 140 includes the communication unit 141, a flexible connector part 142, and a transformer unit 143, and the relay unit 145 is inserted in the flexible connector part 142.

The relay unit 145 includes a drive connector part 145a and a sensor connector part 145b, and the connection flexible portion 121 to which the two power supply flexible portions of the vibrating bodies 102 are connected is inserted in the drive connector part 145a. Thus, a driving voltage from the drive circuit 140 finally drives the two vibrating bodies 102 via the relay unit 145 and the connection flexible portion 121.

The encoder flexible portion 137b of the encoder 137 is inserted in the sensor connector part 145b. Thus, encoder power supply signals from the drive circuit 140 are supplied to the encoder flexible portion 137b via the relay unit 145, driving the sensor unit 137a. In addition, signals of displacement information (or positional information) from the sensor unit 137a are transmitted to the drive circuit 140 via the relay unit 145.

The wiring area of the drive signals and the wiring area of the sensor signals are disposed in different areas in the relay unit 145 without crossing each other as in the first exemplary embodiment. This configuration reduces the influence of the noise from the high-voltage drive signals on position signals of the encoder. In addition, the drive circuit 140 and the drive unit 101 are mounted on the same platform 130 at short distances from each other. Further, the connection flexible portion 121 and the encoder flexible portion 137b are fixed to the relay unit 145. In this way, even when the vibration actuator 200 is moved to be mounted on a fixing base (not illustrated), the connection flexible portion 121 and the encoder flexible portion 137b are not brought closer to each other, reducing the influence of the drive signals on position signals of the encoder.

In the present exemplary embodiment as described above, the position signals of the encoder are less susceptible to the drive signals of the vibration actuator 200, making signals stable with less noise. As a result, the configuration provides increased accuracy of the position detection of the vibration actuator 200, enabling highly accurate driving of the vibration actuator 200.

The communication unit 141 is a universal serial bus (USB) connector, and is connected to a personal computer (an external device) (not illustrated) with a USB cable.

The personal computer transmits control signals to the communication unit 141 via the USB cable, and supplies a drive voltage for the drive circuit 140 to the communication unit 141 via the USB cable. Thus, in the present exemplary embodiment, the vibration actuator 200 can be also driven by the personal computer alone, allowing space-saving for the entire apparatus and cost reduction.

In addition, the vibration actuator 200 can be easily driven with a general—purpose USB cable alone, and there is no need of connecting and disconnecting of the connection flexible portion 121 or the encoder flexible portion 137b. This prevents these flexible portions from being damaged, providing stable driving of the vibration actuator 200.

The drive circuit 140 is disposed such that the USB cable can be connected and disconnected in the Y direction perpendicular to the X direction, which is the driving direction of the vibration actuator 200. This arrangement can prevent interference with the drive target when the USB cable is connected and disconnected. Further, the drive circuit 140 may be disposed so that the USB cable can be connected and disconnected in the Z direction perpendicular to the X direction.

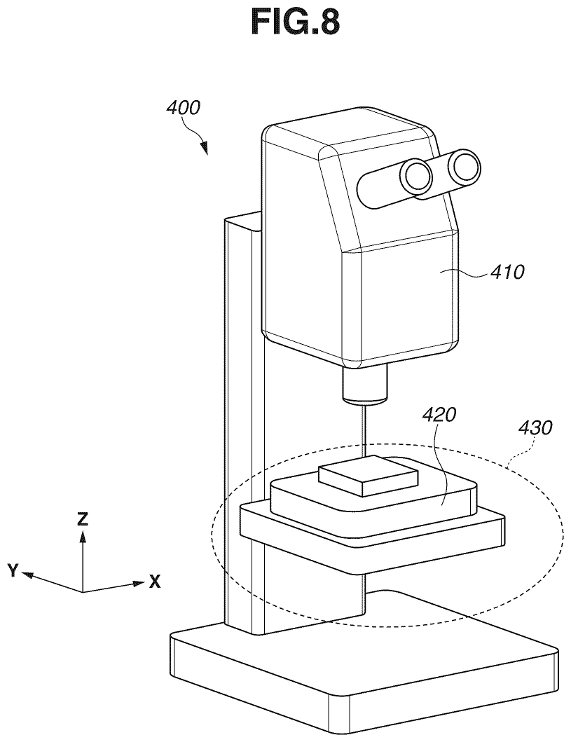

In a third exemplary embodiment, as an example of an optical apparatus or an electronic apparatus equipped with the vibration actuator according to the exemplary embodiments of the present disclosure, the configuration of a microscope 400 including an X-Y stage will be described with reference to FIG. 8. FIG. 8 is a perspective view schematically illustrating a configuration of the microscope 400 (a stage device) including the vibration actuator according to the exemplary embodiments of the present disclosure.

The microscope 400 includes an imaging unit 410 that includes an imaging element (not illustrated) and an optical system (an optical element), and an automatic stage 430. The automatic stage 430 includes a platform, a first vibration actuator (not illustrated) and a second vibration actuator (not illustrated) that are disposed on the platform, and a stage 420 that is provided on the platform and is moved in an X-Y plane.

The first vibration actuator and the second vibration actuator, respectively, use the vibration actuator 100 or 200 according to the first exemplary embodiment or the second exemplary embodiment.

The first vibration actuator is used as a drive device that drives the stage 420 as an example of a member in the X direction of the stage 420. The first vibration actuator is disposed such that the direction of the relative movement between the vibrating body 2 and a part of the contact body 10 matches the X direction of the stage 420.

The second vibration actuator is used as a drive device that drives the stage 420 as an example of a member in the Y direction of the stage 420. The second vibration actuator is disposed such that the direction of the relative movement between the vibrating body 2 and a part of the contact body 10 matches the Y direction of the stage 420.

An object to be observed is placed on the upper surface of the stage 420, and an enlarged image is captured with the imaging unit 410. With a wide observation range, the automatic stage 430 is driven by using the first vibration actuator and the second vibration actuator to move the stage 420 in the in-plane direction to move the object to be observed, changing the imaging region. By combining images captured in different imaging regions by image processing using a computer (not illustrated), a single high-definition image with a wide observation range can be provided.

Further, the vibration actuator (not illustrated) may move at least one of the imaging element and the optical element.

While the present disclosure has been described in detail based on the exemplary embodiments thereof, the present disclosure is not limited to these specific exemplary embodiments, and various modes and forms within the scope are also included in the present disclosure, without departing from the gist of the present disclosure. Furthermore, each of the above-described exemplary embodiments is merely one exemplary embodiment of the present disclosure, and the exemplary embodiments can be appropriately combined.

According to the present disclosure, a vibration actuator capable of driving with high accuracy can be provided. Further, according to the present disclosure, an optical apparatus or an electronic apparatus capable of driving with high accuracy can be provided.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-009254, filed Jan. 25, 2024, which is hereby incorporated by reference herein in its entirety.

What is claimed is:

1. A vibration actuator comprising:
a vibrating body including an electro-mechanical energy conversion element;
a contact body configured to be in contact with the vibrating body and relatively movable with respect to the vibrating body;
a control unit configured to input an electric signal to the vibrating body;
a platform configured to support the vibrating body, the contact body, and the control unit; and
a communication unit configured to receive electric power and an electric signal from an external device.

2. The vibration actuator according to claim 1, comprising a detector configured to detect a relative position between the vibrating body and the contact body.

3. The vibration actuator according to claim 2, wherein a wiring part of the detector is disposed on the platform.

4. The vibration actuator according to claim 2,
wherein the platform includes an output unit configured to output the relative movement and a guide unit configured to guide the output unit in a direction of the relative movement, and
wherein the output unit is provided with a to-be-detected part used by the detector to detect the relative position.

5. The vibration actuator according to claim 1,
wherein a relay unit is connected to the control unit, and
wherein the relay unit includes a drive connector part configured to connect to a wiring part of the vibrating body and a sensor connector part configured to connect to a wiring part of the detector.

6. The vibration actuator according to claim 5, where a wiring area of the drive connector part and a wiring area of the sensor connector part do not cross each other in the relay unit.

7. An electronic device comprising:
a member; and
the vibration actuator according to claim 1 configured to drive the member.

8. An optical device comprising:
the vibration actuator according to claim 1; and
at least one of an optical element and an imaging element that are driven by the vibration actuator.
